(19) United States
(12) Patent Application Publication
(10) Pub. No.: US 2008/0163852 A1
(43) Pub. Date: Jul. 10, 2008

(54) Injector For Fuel Injection Systems of Internal Combustion Engines, in Particular Direct-Injecting Diesel Engines

(76) Inventors: Sebastian Kanne, Schwaikheim (DE); Godehard Nentwig, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/567,125

(22) PCT Filed: Jun. 22, 2004
(86) PCT No.: PCT/DE2004/001301

§ 371 Date: Feb. 6, 2006

(30) Foreign Application Priority Data
Aug. 7, 2003 (DE) 103 36 327.0

(51) Int. Cl. F02M 51/00

(52) U.S. Cl. 123/472; 239/585.1; 239/585.5

(57) ABSTRACT

A fuel injection systems for direct-injection diesel engines, has a piezoelectric actuator contained in an injector body and acted on by a first spring mechanism so that it remains in contact with the injector body at one end and with a sleeve-like booster piston on the other. A nozzle body connected to the injector body has at least one nozzle outlet opening, and in which a stepped first nozzle needle an axially movable, and a second spring mechanism is contained inside the booster piston and the injection pressure hold the first nozzle needle closed. An outer control chamber communicates via at least one leakage gap with a fuel supply under injection pressure; fuel in the control chamber acts on the first nozzle needle in the opening direction. A large diameter rear region of the first nozzle needle is fitted into the internal chamber of the booster piston. A stepped concentric axial recess passing through the first nozzle needle and a second nozzle needle correspondingly stepped is fitted into the first nozzle needle, and a second inner chamber is hydraulically connected to the first outer control chamber. The control chamber volumes and the surfaces of the nozzle needles, matched so that the two nozzle needles open in succession in response to a change to the electrical voltage applied to the piezoelectric actuator.

### PRIOR ART

The invention relates to an injector according to the preamble to claim 1.

An injector of this kind is the subject of the (as yet unpublished) DE . . . (R.305558). The advantages of this known injector lie in its comparatively simple design (small number of separate parts) and in the direct control of the nozzle needle by means of the piezoelectric actuator. The speed of the nozzle needle movement can be adjusted by means of the voltage curve of the piezoelectric actuator. The known injector is also distinguished by the fact that it functions properly without a fuel return.

### ADVANTAGES OF THE INVENTION

The object of the present invention is to use comparatively simple means to create a possibility for the nozzle outlet to be progressively triggered and actuated.

According to the invention, this object is attained in an injector of the type described at the beginning by means of the defining characteristics of claim 1.

Advantageous embodiments of the core concept of the invention are contained in claims 2-9.

The invention advantageously makes it possible to actuate the nozzle outlet progressively by virtue of the fact that the two nozzle needles are triggered sequentially through a corresponding application of voltage to the piezoelectric actuator. The system according to the present invention also has the advantage of functioning properly without a fuel return.

### DRAWINGS

An exemplary embodiment of the invention is shown in the drawings and will be explained in detail in the subsequent description.

FIG. 1 shows a schematic longitudinal section through an embodiment form of a directly controlled common rail injector with a piezoelectric actuator,

FIG. 2 is a schematic depiction of a lower subregion of the injector from FIG. 1 that is enlarged in relation to FIG. 1, and

FIG. 3 is a graph schematically depicting the force that the piezoelectric actuator exerts on the booster piston, plotted over the stroke of the piezoelectric actuator.

### DESCRIPTION OF THE EXEMPLARY EMBODIMENT

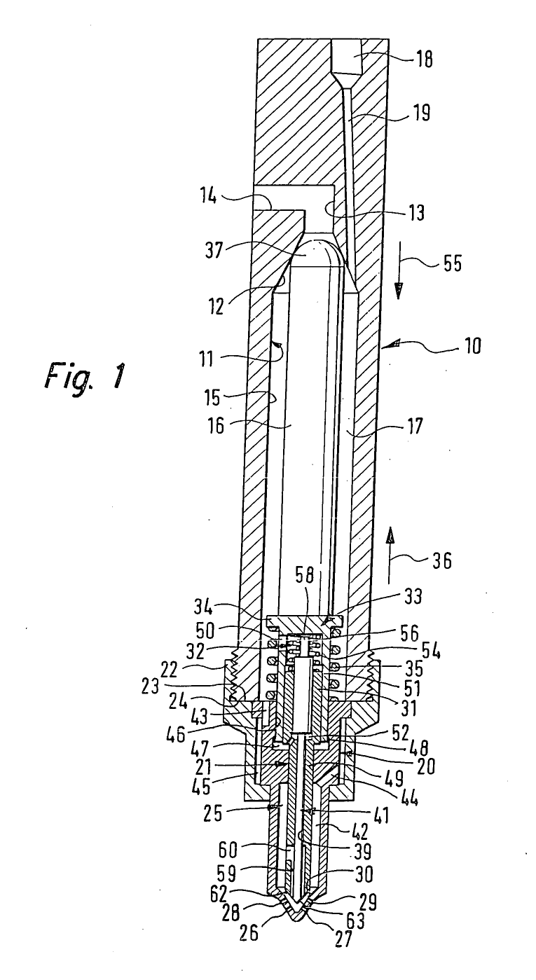

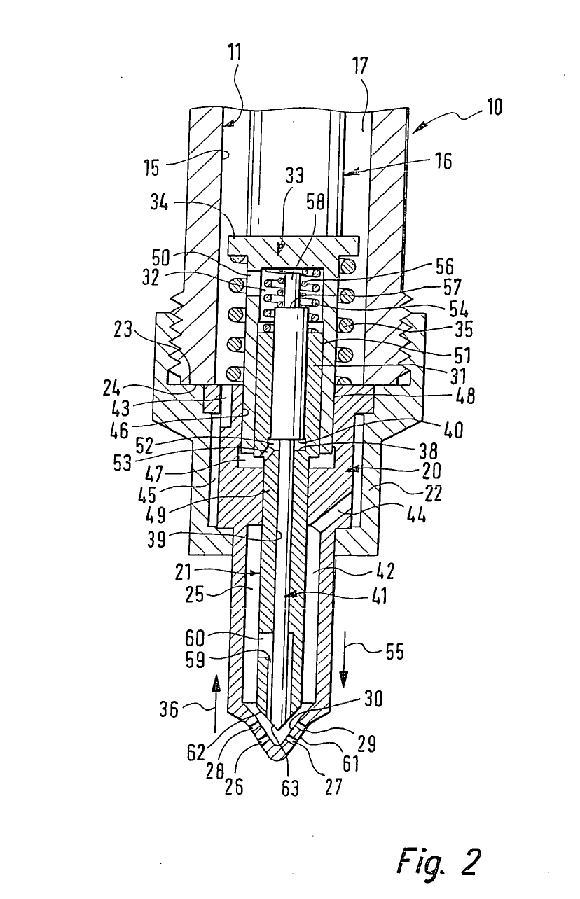

In FIGS. 1 and 2, the reference numeral 10 indicates a cylindrical injector body with a cylindrical recess 11 passing through it for the majority of its longitudinal span. At its upper end, the recess 11 first has a conically tapering segment 12 that transitions into a segment 13, 14, which bends at right angles and then opens to the outside. The cylindrical segment 15 of the recess 11 contains a likewise cylindrical piezoelectric actuator 16 with a comparatively long longitudinal span whose diameter is smaller than the inner diameter of the recess segment 15. This leaves an annular chamber 17 between the outer wall of the piezoelectric actuator 16 and the inner wall of the injector body 10. The required centering of the piezoelectric actuator 16 inside the injector body 10 here is achieved on the one hand by the conical segment 12 of the axial recess 11. On the other hand, flow-permitting spacers (not shown) can be provided as needed, spaced a certain axial distance apart from one another in the annular chamber 17.

The upper bent segment 13, 14 of the recess 11 functions as a cable feedthrough for supplying power to the piezoelectric actuator 16.

At the upper end of the injector body 10, a fuel supply 18, e.g. a high-pressure connection from a common rail system, is provided, which is hydraulically connected to the annular chamber 17 via a pressure conduit 19.

At the lower end of the injector body 10 and coaxial to it, the injector body is adjoined by a nozzle body 20 that contains a first nozzle needle 21. The nozzle body 20 is attached to the injector body 10 by means of a retaining nut (clamping nut) 22 in such a way that its rear end surface 23 comes into sealed contact with a lower end surface 24 of the injector body 10.

In order to contain the first nozzle needle 21, the nozzle body 20 has a multiply stepped inner chamber 25 that is open toward the top and forms a conical valve seat 30 at the bottom, which feeds into a number of nozzle outlet bores 26 through 29.

At its upper end, the first nozzle needle 21 has a large-diameter segment 31 that is fitted into a cylindrical inner chamber 32 of a sleeve-shaped booster piston 33 that is open toward the bottom. The upper end of the booster piston 33 forms a collar 34. A helical compression spring 35, which is contained in the annular chamber 17—in this case surrounding the booster piston 33—and which rests against the end surface 23 of the nozzle body 20 at one end and rests against the collar 34 of the booster piston 33 at the other, keeps the end surface of the booster piston 33 in contact with the piezoelectric actuator. The pressure that the compression spring 35 exerts on the piezoelectric actuator 16 in the arrow direction 36 via the booster piston 33 seals the top end 37 of the piezoelectric actuator 16 against the injector body 10 and the electrical connection (not shown) can thus be routed out of the injector body 10 through the angled bores 13, 14.

A specific feature—particularly visible in FIG. 2—is the fact that the first nozzle needle 21 has a concentric axial recess 39 passing through it, which is stepped by means of a shoulder 38 and has a second nozzle needle 41, which is correspondingly stepped by means of a shoulder 40, fitted into it in an axially movable fashion.

The lower part of the nozzle body 20—as a component of the inner chamber 25 of the nozzle body—contains a cylindrical pressure chamber 42 that concentrically encompasses the first nozzle needle 21 and is hydraulically connected to the annular chamber 17 of the injector body 10 via bores 43, 44 in the nozzle body 20 and an annular chamber 45 contained between the nozzle body 20 and the clamping nut 22.

At the top, the inner chamber 25 of the nozzle body 20 has a stepped diametrical expansion 46 in which the booster piston 33 is guided so that a first control chamber 47 contained in the expanded inner chamber part 46 below the booster piston 33 is hydraulically connected to the annular chamber 17 of the injector body 10 via a leakage gap 48 (see FIG. 2 in particular). A segment 49 of the nozzle body inner chamber 25 with a comparatively small diameter serves to guide the first nozzle needle 21 inside the nozzle body 20. This guiding fit 49 is also designed to have a leakage gap. The first control chamber 47 is thus hydraulically connected via the second leakage gap 49 to the cylindrical chamber 42, which is in turn is exposed to high pressure from the annular chamber 17 of the injector body 10 via the recesses 43 through 45. The inner chamber 32 of the booster piston 33 extending above the nozzle needle 21 is likewise hydraulically connected to the highly pressurized annular chamber 17 of the injector body 10 via a lateral bore 50 in the booster piston 33. The upper (thicker) segment 31 of the first nozzle needle 21 is guided in the booster piston 33 so that an (additional) leakage gap 51 is produced (see FIG. 2). This (third) leakage gap 51 consequently hydraulically connects the first control chamber 47 to the highly pressurized annular chamber 17 of the injector body 10.

Another specific feature is the fact that inside the axial recess 39—between its shoulder 38 and the shoulder 40 of the second nozzle needle 41—a (second) inner chamber 52 is formed, which is hydraulically connected to the first (outer) control chamber 47. The second (inner) control chamber 52 has a smaller volume than the first (outer) control chamber 47. The two control chambers communicate hydraulically via a bore 53 passing obliquely through the first nozzle needle 21 in the vicinity of its shoulder 38.

As is particularly clear from FIG. 2, moreover, the inner chamber 32 of the booster piston 33 contains a (second) helical compression spring 54 that exerts a force on the first nozzle needle 21 in the closing direction (arrow 55). The (second) compression spring 54 keeps the first nozzle needle 21 closed during pauses between injections and when the vehicle is not operating. FIGS. 1 and 2 show the open position of the two nozzle needles 21 and 41. In this position, an injection is taking place through all of the outlet openings—i.e. in the example shown, the bores 26 through 29. In the process, fuel travels out of the cylindrical pressure chamber 42, through the outlet bores 26 through 29, and into the cylindrical combustion chamber (not shown) of the engine.

The first control chamber 47 at the bottom end of the booster piston 33 has a hydraulic length compensation function and also serves as a hydraulic booster for the expansion movement of the piezoelectric actuator 16 in relation to the first nozzle needle 21.

FIGS. 1 and 2 (especially FIG. 2) also show that the third spring mechanism 56 contained inside the booster piston 33 acts on the piezoelectric actuator end (upper end) of the second nozzle needle 41 in the direction toward the closed position (arrow 55). The third spring mechanism 56 is a helical compression spring, which is encompassed by and concentric to the second spring mechanism (helical compression spring 54) and which rests against the second nozzle needle 41 at one end and at the other end, rests against the piezoelectric actuator end (upper end) of the inner chamber 32 of the booster piston. To accomplish this, a shoulder 57 is provided at the piezoelectric actuator end (upper end) of the second nozzle needle 41, adjoined by a smaller-diameter pin piece 58 onto which the helical compression spring 56 is placed.

As is also shown in FIG. 2, the axial recess 39 of the first nozzle needle 21 through which the second nozzle needle 41 passes has a diametrical expansion in its (lower) region oriented toward the nozzle outlets. This produces an annular, cylindrical cavity 59 encompassing the second nozzle needle 41 in its (lower) region oriented toward the nozzle outlets. The first nozzle needle 21 contains a radial bore 60 that hydraulically connects the cylindrical pressure chamber 42 to the annular, cylindrical cavity 59.

Another specific feature is that the (lower) end region 61 of the nozzle body 20, which contains the nozzle outlet openings 26 through 29, and the end sections 62, 63 of the two nozzle needles 21, 41, which function as closing bodies, are embodied as conical so that when the nozzle needles 21, 41 are both in the closed position or open position (FIGS. 1 and 2), their end sections 62, 63 combine to form a single conical surface. The nozzle outlet openings 26 through 29 and the conical end sections 62, 63 of the two nozzle needles 21, 41 are matched to each other in their dimensions and position so that the two radially inner nozzle outlet openings 26, 27 are controlled by the conical end section 63 of the second nozzle needle 41 and the two radially outer nozzle needle outlet openings 28, 29 cooperate with the conical end section 62 of the first nozzle needle 21.

The injector described above functions as follows: The piezoelectric actuator 16 is not supplied with current during injection pauses. If the piezoelectric actuator 16 is then electrically triggered, it expands and moves the booster piston 33 downward (in arrow direction 55) counter to the force of the springs 35, 54, and 56. The volume of the control chambers 47 and 52 decreases and the pressure in the control chambers 47, 52 increases. As a result, a force is exerted on both nozzle needles 21 and 41 in the opening direction (arrow 36). As soon as the opening force exceeds the combination of pressure-induced and spring-induced forces, then the nozzle needle that requires the lesser opening force moves in the opening direction (arrow 36). In the exemplary embodiment shown in FIGS. 1 and 2, this is the second (inner) to nozzle needle 41. This is the case because its pressure surface oriented toward the combustion chamber of the engine is smaller than that of the first (outer) nozzle needle 21. As soon as the second (inner) and nozzle needle 41 opens, the pressure in the control chambers 47, 52 stops decreasing. After a short stroke (approx. 0.1 mm, depending on the hydraulic flow) the second nozzle needle 41 strikes its upper stop in which the pin piece 58 comes into contact with the inner (upper) end surface of the booster piston 33. In order now to also move the first (outer) nozzle needle 21 into its open position (FIGS. 1 and 2), it is necessary to (further) increase the electrical voltage applied to the piezoelectric actuator 16. The piezoelectric actuator 16 thus expands again in the axial direction (arrow 55) until the first nozzle needle 21 also moves into the open position (FIGS. 1 and 2), thus opening the nozzle outlet openings 28, 29. The distance boosting achieved by the booster piston 33 permits the first nozzle needle 21 to execute a maximum stroke that is significantly greater than the stroke of the piezoelectric actuator 16. (Since the first nozzle needle 21 is supplied with fuel both internally and externally, the stroke can be significantly less than 200 μm.) As soon as the nozzle needles 21, 41 have left the stroke range of seat throttling, they are pressure balanced. At that point, the piezoelectric actuator 16, by means of the booster piston 33, need only keep the pressure in the control chambers 47, 52 far enough above the high pressure (rail pressure) of the fuel supplied at 18 (FIG. 1) to overcome the resistances of the springs 35, 54, and 56. The longest possible triggering duration is determined by the leakage from the control chambers 47, 52. If the pressure in the control chambers 47, 52 falls to the rail pressure, then the nozzle needles 21, 41 close. In order to actively close the nozzle needles 21, 41, it is necessary to reduce the electrical voltage applied to the piezoelectric actuator 16 to zero. As a result, the piezoelectric actuator 16 constricts and the pressure in the control chambers 47, 52 falls below the rail pressure. This exerts closing forces on the nozzle needles 21, 41, which move in the arrow direction 55 and close the nozzle outlet openings 26 through 29. The first (outer) compression spring 35 prevents the piezoelectric actuator 16 from moving away from the booster piston 33.

In the exemplary embodiment shown in FIGS. 1 and 2, therefore, the volumes of the control chambers 47, 52 and the surfaces of the nozzle needles 21, 41—which are acted on by the control chamber pressures, the pressure of the fuel supply 18, 19, and the spring mechanism pressure—are matched to each other so that the two nozzle needles 21, 41 open in succession in response to a change to the electrical voltage applied to the piezoelectric actuator 16 and can be closed at the same time by switching off the current to the piezoelectric actuator 16.

A simple calculation example is used below to demonstrate the forces and powers required to execute the above-described function:

With an outer diameter of the second (inner) nozzle needle 41 of 1.7 mm (seat diameter: 1.6 mm), at a rail pressure of 1600 bar, 321 N are required in order to move the second nozzle needle 41 into the open position (FIGS. 1 and 2). With a stroke boosting of 4:1 for the second nozzle needle 41, this corresponds to 1284 N of piezoelectric force in addition to the spring forces. As soon as the second nozzle needle 41 has opened by a few micrometers, then the (additional) required opening force drops very sharply since the pressure against the underside of the needle increases. If the second nozzle needle 41 has executed its entire stroke—0.08 mm is sufficient since the radially inner nozzle needle openings 26, 27 in this example have the lower hydraulic flow, then the piezoelectric actuator 16 has lengthened by 0.02 mm (disregarding leakage losses and compressibility). A force of 482.54 N is required to open the first (outer) nozzle needle 21 if it has an inner diameter (=inner seat diameter) of 2.0 mm and an outer diameter of 2.8 mm. With a stroke boosting of 1:3, this corresponds to a force of 1450 N in the piezoelectric actuator 16. This force is higher than the opening force of the second (inner) nozzle needle 41.

(With an appropriate selection of different stroke boostings for the first and second nozzle needles (21 and 41), it is also possible—if so desired—to open the first (outer) nozzle needle (21) first and only then to open the second (inner) nozzle needle (41).)

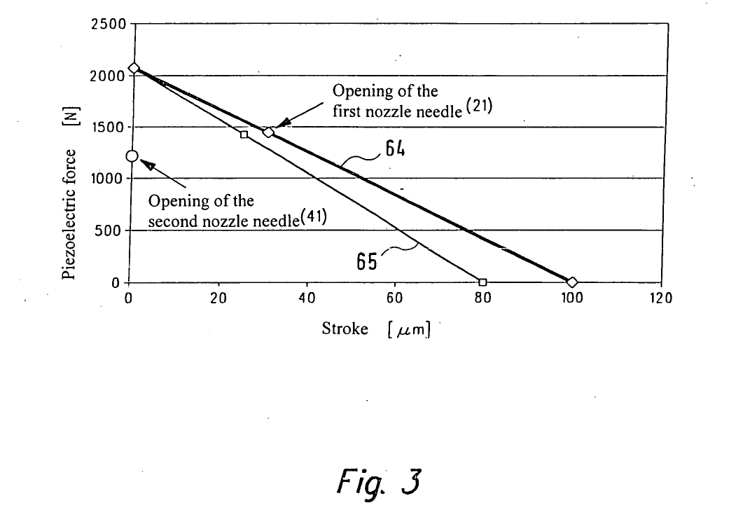

In order to achieve the required first nozzle needle (21) opening stroke of 0.15 mm—more is not necessary since the first nozzle needle (21) is supplied with fuel both internally and externally, the piezoelectric actuator (16) must expand lengthwise by 0.05 mm more. In this example, this yields a required total stroke of the piezoelectric actuator (16) of approx. 0.075 millimeters in addition to losses from leakage and compressibility. Assuming that a total of an additional 0.025 mm is required in order to compensate for losses, then it is possible to use a piezoelectric actuator that follows the force/path curve labeled with reference numeral 64 in FIG. 3.

With an increase in the seat angle and a slightly stricter layout of the required strokes of the first and second nozzle needles (21 and 41), it is also possible to achieve significantly smaller values for the maximum force and stroke. Thus, for example, with a seat angle of 90° (in the exemplary embodiment shown in FIGS. 1 and 2, the seat angles are somewhat less than 90°), the second (inner) nozzle needle 41 only requires a stroke of 60 μm and the first (outer) nozzle needle 21 only requires a stroke of 100 μm. With the same boosting ratios and the same allowance for leakage, this would result in a significantly smaller maximum stroke of the piezoelectric actuator 16 of only 80 μm (see curve 65 in FIG. 3).

1-9. (canceled)

10. An injector for fuel injection systems of internal combustion engines, in particular direct-injection diesel engines, the fuel injector system comprising
a piezoelectric actuator contained in an injector body and acted on by a first spring mechanism so that it remains in contact with the injector body at one end and with a sleeve-like booster piston on the other;
a nozzle body connected to the injector body and having at least one nozzle outlet opening, and in which a stepped first nozzle needle is guided in an axially movable fashion;
a second spring mechanism contained inside the booster piston and, together with the injection pressure acting on the rear end of the first nozzle needle, holds the first nozzle needle in the closed position;
an outer control chamber at the nozzle needle end of the booster piston and communicating via at least one leakage gap with a fuel supply under injection pressure with the fuel contained in the outer control chamber acting on the first nozzle needle in the opening direction;
a rear region of the first nozzle needle fitted into an internal chamber of the booster piston, the rear region of the first nozzle needle having a larger diameter than a nozzle outlet region of the first nozzle needle,
a concentric axial recess passing through the first nozzle needle, which recess is stepped by means of a shoulder,
a second nozzle needle which is correspondingly stepped by means of a shoulder fitted into the concentric axial recess in an axially movable fashion, and
a second inner chamber formed inside the axial recess between its shoulder and the shoulder of the second nozzle needle, which second inner chamber being hydraulically connected to the first outer control chamber;
the control chamber volumes and the surfaces of the nozzle needles which are acted on by the control chamber pressures, the pressure of the fuel supply, and the spring mechanism pressure being matched to each other so that the two nozzle needles open in succession in response to a change to the electrical voltage applied to the piezoelectric actuator.

11. The injector according to claim 10, wherein the fluid pressure-loaded surfaces of the second nozzle needle in comparison to the fluid pressure-loaded surfaces of the first nozzle needle are designed so that the second nozzle needle opens at a comparatively low control chamber pressure corresponding to a comparatively low piezoelectric actuator voltage, but the first nozzle needle only opens at a comparatively high control chamber pressure corresponding to a comparatively high piezoelectric actuator voltage.

12. The injector according to claim 10, wherein the two control chambers communicate with each other hydraulically via a bore passing obliquely through the first nozzle needle.

13. The injector according to claim 11, wherein the two control chambers communicate with each other hydraulically via a bore passing obliquely through the first nozzle needle.

14. The injector according to claim 10, wherein the inner chamber of the booster piston is hydraulically connected to the fuel supply, the injector further comprising a third spring mechanism contained inside the booster piston and acting on the piezoelectric actuator end of the second nozzle needle in the direction toward the closed position.

15. The injector according to claim 11, wherein the inner chamber of the booster piston is hydraulically connected to the fuel supply, the injector further comprising a third spring mechanism contained inside the booster piston and acting on the piezoelectric actuator end of the second nozzle needle in the direction toward the closed position.

16. The injector according to claim 12, wherein the inner chamber of the booster piston is hydraulically connected to the fuel supply, the injector further comprising a third spring mechanism contained inside the booster piston and acting on the piezoelectric actuator end of the second nozzle needle in the direction toward the closed position.

17. The injector according to claim 14, wherein the spring mechanism that acts on the nozzle needle in the closing direction is a helical compression spring that is situated coaxial to the first nozzle needle and rests against its rear end surface at one end and at the other end, rests against the piezoelectric actuator end of the internal chamber of the booster piston, and wherein
the third spring mechanism is also a helical compression spring, which is encompassed by and concentric to the second spring mechanism and which rests against the second nozzle needle at one end and at the other end, rests against the piezoelectric actuator end of the inner chamber of the booster piston.

18. The injector according to claim 15, wherein the spring mechanism that acts on the nozzle needle in the closing direction is a helical compression spring that is situated coaxial to the first nozzle needle and rests against its rear end surface at one end and at the other end, rests against the piezoelectric actuator end of the internal chamber of the booster piston, and wherein
the third spring mechanism is also a helical compression spring, which is encompassed by and concentric to the second spring mechanism and which rests against the second nozzle needle at one end and at the other end, rests against the piezoelectric actuator end of the inner chamber of the booster piston.

19. The injector according to claim 16, wherein the spring mechanism that acts on the nozzle needle in the closing direction is a helical compression spring that is situated coaxial to the first nozzle needle and rests against its rear end surface at one end and at the other end, rests against the piezoelectric actuator end of the internal chamber of the booster piston, and wherein
the third spring mechanism is also a helical compression spring, which is encompassed by and concentric to the second spring mechanism and which rests against the second nozzle needle at one end and at the other end, rests against the piezoelectric actuator end of the inner chamber of the booster piston.

20. The injector according to claim 17, further comprising a shoulder at the piezoelectric actuator end of the second nozzle needle, adjoined by a smaller-diameter pin piece the helical compression spring serving as the third spring mechanism being placed onto the pin piece.

21. The injector according to claim 18, further comprising a shoulder at the piezoelectric actuator end of the second nozzle needle, adjoined by a smaller-diameter pin piece the helical compression spring serving as the third spring mechanism being placed onto the pin piece.

22. The injector according to claim 19, further comprising a shoulder at the piezoelectric actuator end of the second nozzle needle, adjoined by a smaller-diameter pin piece the helical compression spring serving as the third spring mechanism being placed onto the pin piece.

23. The injector according to claim 10, wherein the nozzle outlet region of the nozzle body contains a cylindrical pressure chamber that concentrically encompasses the first nozzle needle and is hydraulically connected to the fuel supply under injection pressure, wherein
the axial recess of the first nozzle needle through which the second nozzle needle passes has a diametrical expansion in its nozzle outlet region, thus producing an annular, cylindrical cavity encompassing the second nozzle needle in its nozzle outlet region, and wherein the first nozzle needle being at least one radial bore let into it, which hydraulically connects the cylindrical pressure chamber to the annular, cylindrical cavity.

24. The injector according to claim 11, wherein the nozzle outlet region of the nozzle body contains a cylindrical pressure chamber that concentrically encompasses the first nozzle needle and is hydraulically connected to the fuel supply under injection pressure, wherein
the axial recess of the first nozzle needle through which the second nozzle needle passes has a diametrical expansion in its nozzle outlet region, thus producing an annular, cylindrical cavity encompassing the second nozzle needle in its nozzle outlet region, and wherein the first nozzle needle being at least one radial bore let into it, which hydraulically connects the cylindrical pressure chamber to the annular, cylindrical cavity.

25. The injector according to claim 12, wherein the nozzle outlet region of the nozzle body contains a cylindrical pressure chamber that concentrically encompasses the first nozzle needle and is hydraulically connected to the fuel supply under injection pressure, wherein
the axial recess of the first nozzle needle through which the second nozzle needle passes has a diametrical expansion in its nozzle outlet region, thus producing an annular, cylindrical cavity encompassing the second nozzle needle in its nozzle outlet region, and wherein the first nozzle needle being at least one radial bore let into it, which hydraulically connects the cylindrical pressure chamber to the annular, cylindrical cavity.

26. The injector according to claim 10, wherein the nozzle outlet of the nozzle body comprises one or more radially outer nozzle outlet openings controlled by the first nozzle needle and one or more radially inner nozzle outlet openings controlled by the second nozzle needle.

27. The injector according to claim 11, wherein the nozzle outlet of the nozzle body comprises one or more radially outer nozzle outlet openings controlled by the first nozzle needle and one or more radially inner nozzle outlet openings controlled by the second nozzle needle.

28. The injector according to claim 12, wherein the nozzle outlet of the nozzle body comprises one or more radially outer nozzle outlet openings controlled by the first nozzle needle and one or more radially inner nozzle outlet openings controlled by the second nozzle needle.

29. The injector according to claim 10, wherein the end region of the nozzle body which contains the nozzle outlet openings and the end sections of the two nozzle needles which function as closing bodies, are embodied as conical so that when the nozzle needles are both in the closed position or open position, their end sections combine to form a single conical surface.
